(19) United States
(12) Patent Application Publication
(10) Pub. No.: US 2022/0245380 A1
(43) Pub. Date: Aug. 4, 2022

(54) LIGHT IDENTIFICATION SYSTEM FOR UNMANNED AERIAL VEHICLES

(71) Applicant: Skyway Technologies Corp., San Rafael, CA (US)

(72) Inventors: Clifford FERNANDEZ, San Rafael, CA (US); Kurt GRUTZMACHER, San Rafael, CA (US); Derrick Harry LEWIS, San Rafael, CA (US)

(21) Appl. No.: 17/167,655

(22) Filed: Feb. 4, 2021

(51) Int. Cl. G06K 9/00; B64C 39/02; B64D 47/06

(52) U.S. Cl. CPC G06K 9/00624; B64C 39/024; G06K 2209/23; B64D 2203/00; B64D 47/06

(57) ABSTRACT

A drone identification system including a drone having an LED “license plate” and an identification device is disclosed. The drone's LEDs emit a color pattern signal that is captured by the identification device, which is then used to uniquely identify the drone. Specifically, the identification device translates the color pattern signal into a unique identification code that is used to identify the drone. The identification code may be transmitted to a server to store the identification information in a directory for future use.

### BACKGROUND

Aircraft, such as droned or unmanned aerial vehicles (UAVs), use various identification systems to identify themselves to one another and/or to personnel on the ground. Currently, drones are identified using radio signals, where a drone sends an associated identifier (e.g., a drone ID) via a radio signal to identifying equipment. However, such identification can be problematic due to radio interference and/or other cable and antenna problems. Thus, as drones, small aircraft such as UAVs, small passenger drones, and aircraft delivery vehicles continue to provide utility, new identifications systems and methods would be useful.

### BRIEF DESCRIPTION OF THE DRAWINGS

FIG. 1 illustrates a drone operable to be in communication with multiple entities.

FIG. 2 illustrates two examples of LED patterns used to identify a drone.

FIG. 3 illustrates an embodiment of a drone identification system.

FIG. 4 is a flow diagram illustrating a light emission method performed by a drone.

FIG. 5 is a flow diagram illustrating an identification method performed by an identification device of the identification system.

FIG. 6 is a flow diagram illustrating a method performed by a server of the identification system.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Systems and methods for identifying drones and other unmanned aerial vehicles (UAVs) are described. The systems include a drone, an identification system for processing drone identification data, and a server for storing the drone identification data. The drone includes a light emitting diode (e.g., a beacon) that emits a light signal or pattern, which is captured by the identification system. The light signal or pattern, in some cased, acts as an LED “license plate” for the drone. The identification system translates the received light signal and transmits this data to the server and/or external computer. The identification system identifies the drone using the translated light signal. The server then stores the color pattern signal and related data for future use.

It is to be understood that the following explanation is merely exemplary in describing the devices and methods of the present disclosure. Accordingly, any number of foreseeable modifications, changes, and/or substitutions are contemplated without departing from the spirit and scope of the present disclosure. The phrases “in some implementations,” “according to some implementations,” “in the implementations shown,” “in other implementations,” and the like generally mean the particular feature, structure, or characteristic following the phrase is included in at least one implementation of the present technology and can be included in more than one implementation. In addition, such phrases do not necessarily refer to the same implementations or different implementations.

### Examples of Drone Identification Systems

As described herein, the systems and methods provide an identification system for drones to easily identify the drones for other drones and/or ground equipment or devices.

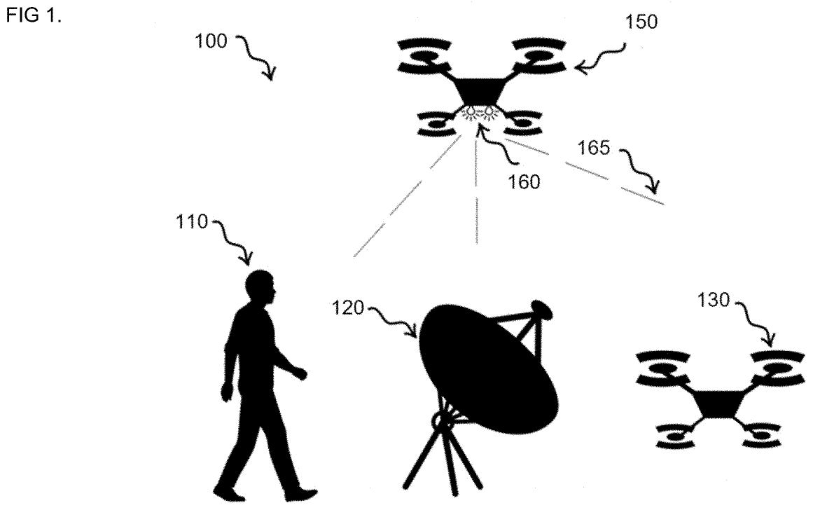

FIG. 1 is a diagram illustrating the components of a drone communication environment 100. A drone 150 includes an RGB light emitting diode (LED) 160 or beacon. The LED 160 emits a color pattern signal 165 that can be identified by a user or air traffic controller 110, a drone identification system 120, another drone 130, or any other appropriate entity, equipment, or device. The color pattern signal 165 includes a particular sequence of colors generated in accordance with the internal operations of the drone 150. The unique color pattern identifies the particular drone 150 to the user 110, which may include government officials or agencies, commercial companies, or individuals. In some cases, the drone 150 includes two or more LEDs 160, in order to provide a redundancy system where a backup LED or LEDs can continue to emit the color pattern signal 165 in the event that one LED fails.

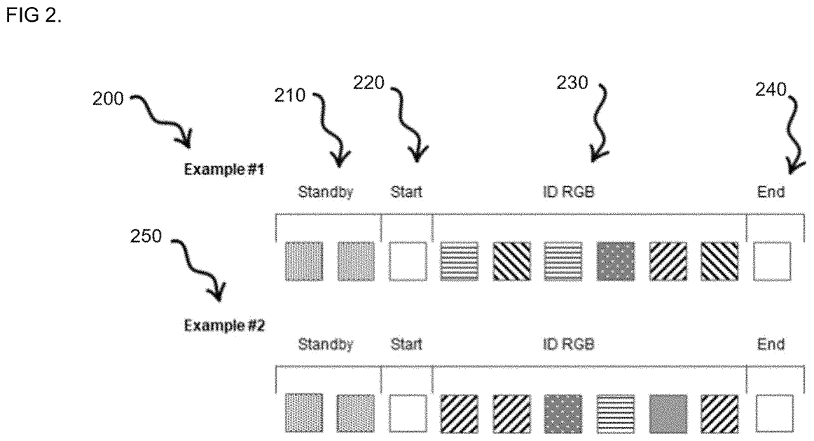

FIG. 2 illustrates examples of the color pattern signal 165 transmitted by LED 160 discussed in FIG. 1. In some embodiments, the color pattern signal 165 that identifies a drone 150 includes four phases or patterns: Standby 210, Start 220, ID 230, and End 240. The Standby phase 210 is a preparation phase presented before the sequence that prepares or informs a target drone identification system to prepare to identify the drone. In some cases, the Standby phase's 210 color pattern sequence may be common to some or all drones, such as a fleet of drones.

During the Standby phase 210, the LED 160 emits two pulses of the same color. In identification pattern examples 200 and 250, the LED 160 emits two pulses of blue light during the Standby phase 210. The Standby phase 210 is followed by a Start phase 220. The Start phase 220 is a phase that indicates to the user that the ID signal will immediately follow. During Start phase 220, the LED 160 emits one pulse of light. In identification pattern examples 200 and 250, the LED 160 emits one pulse of white light.

The Start phase 220 is followed by the ID phase 230. The ID phase 230 is the color pattern signal unique to each drone 150. During the ID phase 230, the LED 160 emits a number of light pulses that uniquely identify a drone 150. In some embodiments, the ID phase includes six pulses of light. In identification pattern example 200, the LED 160 emits pulses of light in the following order: Green, Yellow, Green, Red, Purple, Yellow. In example 250, the LED 160 emits pulses of light in the following order: Purple, Purple, Red, Green, Blue, Yellow. Although the ID phase of examples 200 and 250 each include six light pulses, any appropriate number of pulses may be used. The End phase 240 indicates that the ID phase 230 has ended. During the End phase 240, the LED 160 emits one pulse of light. In identification pattern examples 200 and 250, the LED 210 emits one pulse of white light.

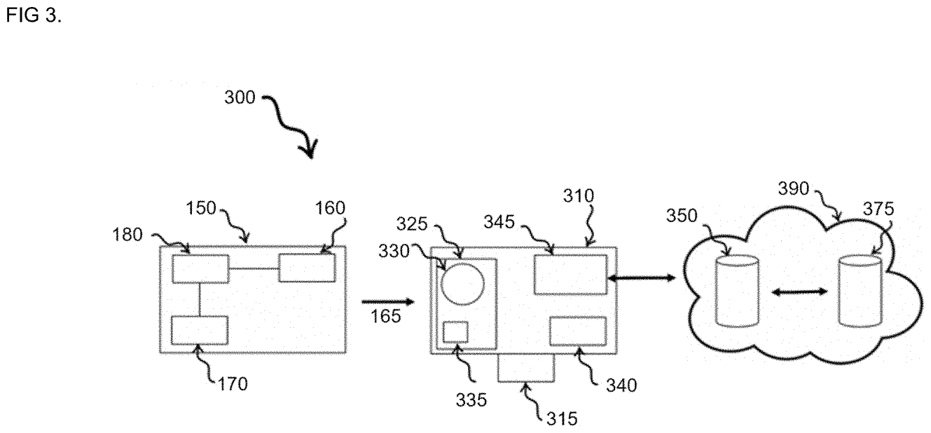

FIG. 3 is a block diagram of a drone identification system 300, where the drone 150 is identified via an emitted color pattern signal 165. The drone 150 includes a storage medium 170, Central Processing Unit (CPU) 180, and an LED 160. The storage medium 170 stores the drone's serial number in an encrypted file. The CPU 180 accesses the encrypted file in the storage medium 170 and decrypts the file to identify the drone 150 serial number. The serial number is used to generate a color pattern signal 165. The drone 150 can transmit the color pattern signal 165 to an identification device 310, such as those described herein.

The identification device 310 may send the color pattern signal 165 to an external computer system 390 for storage and future retrieval. The color pattern signal 165 may be stored into a computer/cloud server 390 after the identification device 310 captures, identifies, and stores the color pattern signal 165 emitted by a drone 150 via the LED 160. The identification device 310 includes a display 315, a camera 325 having a lens 330 and a Complementary Metal Oxide Semiconductor (CMOS) sensor 335, a translator 340, and a cellular modem 345 or communication device.

During operation, the camera 325 of the identification device 310 captures the color pattern signal 165 via the lens 330 and the CMOS sensor 335. Then, the translator 340 transcodes the captured image. In an embodiment, the identification device 310 may identify the drone using data from the translator 340 as a result of the transcoding, and display 315 the drone's identification and other relevant information onto the display 315.

In some embodiments, the transcoded image is transmitted to a computer/cloud server 390 through the cellular modem 345. The computer/cloud server 390 contains software 350 that is connected to a directory and database 375 and is able to identify the drone 150 based on the transcoded image. The computer/cloud server 390 sends identification and other relevant information back to the identification device 310, so that the information can be shown to users on the display 315. This process allows the identification device 310 to identify the color pattern signal 165. This identification information is either subsequently sent back and displayed 315 on the identification device 310 or stored in the database 375 that contains a registry of color pattern signals 165 in alphanumeric values. The drone identification process is self-sufficient of the computer/cloud server 390. The computer/cloud server 390 may identify the drone data, however, in other embodiments, the computer/cloud server 390 serves to store drone location data, allowing users to review drone data when they are not monitoring drone data in real time.

FIG. 3 and the discussion herein provide a brief, general description of the components of the drone identification system. Although not required, aspects of the system are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, (e.g., smart phones), multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network.

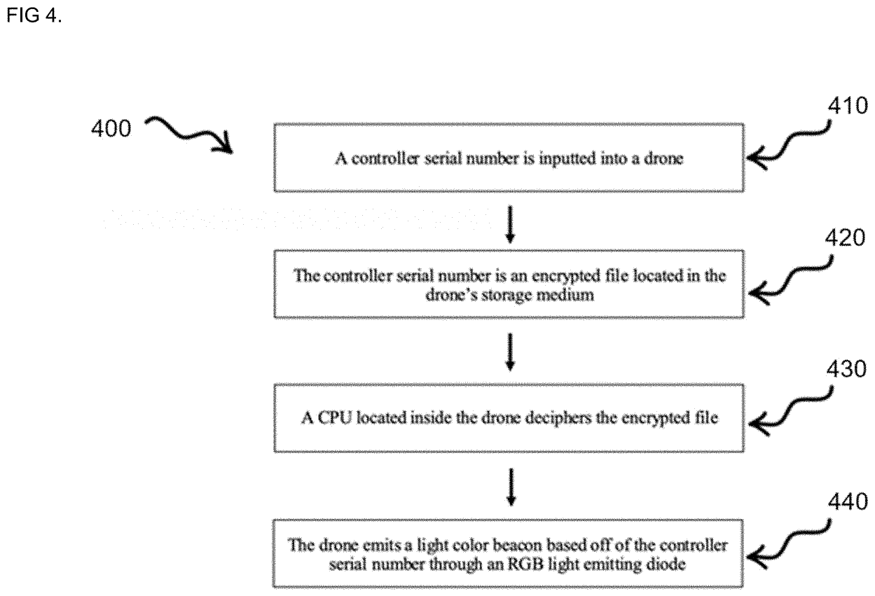

FIG. 4 depicts a method 400 of a drone 150 emitting a color pattern signal 165 through an LED 160. Aspects of the method 400 may be performed by the drone 150 and, accordingly, is described herein merely by way of reference thereto. It will be appreciated that the method 400 may be performed on any suitable hardware.

As shown in step 410, a drone 150 is assigned a unique controller serial number. In some cases, step 410 may be performed by the drone's manufacturer. In other cases, a user may input a serial number into the drone 150. The serial number may be encrypted so as to protect malicious altering of the drone's serial number.

In step 420, the encrypted file is stored in a storage medium 170. In step 430, a central processing unit (CPU) 180 of the drone 150 accesses and decrypts the encrypted file. The decryption is performed through a two-step process. First, a decipher key is used to unlock the encrypted file. Second, a decoder is used to translate the alphanumeric value to a color pattern signal 165. Once translated, in step 440, the drone 150 emits a color pattern signal 165 through the LED 160. This alphanumeric value allows for a drone 150 to emit a unique color pattern signal 165.

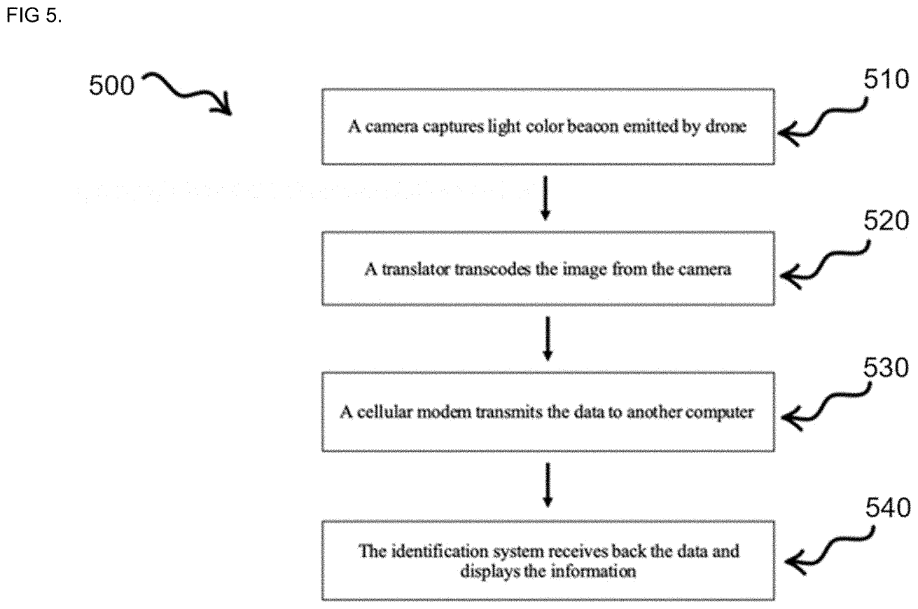

FIG. 5 describes a method 500 of identifying, via an identification device 310, a drone 150 based on transcoded images. Aspects of the method 500 may be performed by the identification device 310 and, accordingly, is described herein merely by way of reference thereto. It will be appreciated that the method 500 may be performed on any suitable hardware.

In step 510, the identification device 310, used to identify a drone 150, captures the color pattern signal 165 emitted by the drone 150 through the camera 325 containing the CMOS sensor 335 and the lens 330. In step 520, to read the color pattern signal 165 that was captured by the camera 325, a translator 340, including a small-sized static random-access memory (SRAM) command, software, or firmware, transcodes the image. In step 530, the transcoded image is sent through the cellular modem 345 that transmits the data through the internet to another computer/cloud 390. In step 540, the information is then communicated back to the identification device 310 and an LCD 315 on the system displays the information.

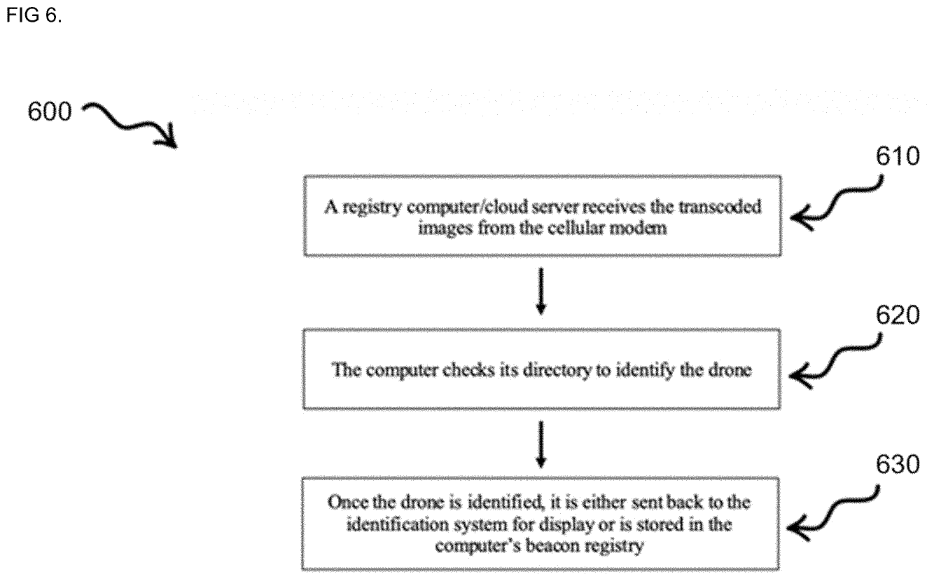

FIG. 6 illustrates a method 600 of identifying a drone 150through its output data, such as its color pattern signal 165. Aspects of the method 600 may be performed by the identification device 310 and, accordingly, is described herein merely by way of reference thereto. It will be appreciated that the method 600 may be performed on any suitable hardware.

In step 610, a registry computer/cloud server 390 receives transcoded images from the identification device 310, as described in FIG. 5. In step 620, the computer/cloud server 390 then uses software to check its directory or registry 350 to identify the drone. For example, the directory/registry 350 can include information that maps or related color patterns to drone identifiers. Once the drone 150 is identified, in step 630, information is sent back to the identification device 310 for display 315. The information may also be stored in the computer/cloud 390′s beacon (e.g., LED) registry 375, where the beacon registry 375 is a database that contains a registry of beacon alphanumeric values or other identifier mapped information.

Thus, in some embodiments, identifying a drone includes capturing images of a color pattern emitted from a light emitting diode (LED) of the drone, transcoding the captured images to extract the color pattern from the captured images, comparing the color pattern to a registry of information that relates color patterns to drone identifiers, and identifying the drone based on the comparison performed via the registry. In cases where the emitted color pattern includes a standby phase and an identification phase, the system utilizes the identification phase of the emitted color pattern when identifying the drone via the registry.

The systems and methods described herein have numerous benefits. With the growing number of drones, regulation and compliance in the drone industry is desired. Today, there are growing concerns as unregulated drones enter government airspace and airport areas. Drones are not allowed to fly over government airspace and ensuring compliance with this rule becomes complicated as the growing number of unregistered drones fly around. As drones enter airport areas, air traffic controllers are unable to efficiently carry out their job leading to a myriad of delays with flight takeoffs and landings. Therefore, a standardized method to identify drones is needed.

While the present disclosure describes drone identification using a sequence of colored lights, the method can be used in conjunction with other drone identification systems and methods. For example, a drone may be identified by emitting the disclosed color light sequence, and alternatively or at the same time, radio signals that uniquely identify the drone. In addition, the disclosed system may also be used in conjunction with radar and sonar systems used for drone detection.

The breadth and scope of the present disclosure should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the disclosure(s) set out in any claims that may issue from this disclosure. Specifically, and by way of example, the claims should not be limited by the language chosen under a heading to describe the so-called technical field. Further, a description of a technology in the “Background” is not to be construed as an admission that technology is prior art to any embodiment(s) in this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

We claim:

1. An unmanned aerial vehicle (UAV) identification system comprising:
an identification device having:
a receiving device operable to receive a color pattern signal from an unmanned aerial vehicle (UAV);
a processor operable to translate the color pattern signal into a translated identification code;
a display operable to display the translated identification code; and
a transmitter operable to transmit the translated identification code to a server; and
a server operable to:
receive the translated identification code;
identify the unmanned aerial vehicle (UAV) based on the translated identification code; and
store the translated identification code and information associated with the identified unmanned aerial vehicle (UAV) in a directory of the server.

2. The unmanned aerial vehicle (UAV) identification system of claim 1, wherein the unmanned aerial vehicle (UAV) includes:
a light emitting diode (LED); and
an identification code that identifies the unmanned aerial vehicle (UAV);
wherein the LED transmits a color pattern signal corresponding to the identification code of the unmanned aerial vehicle (UAV).

3. A system for identifying a drone, the system comprising:
a light emitting diode (LED); and
a processor that causes the light emitting diode (LED) to emit a color pattern signal indicative of the drone, by:
accessing an identification code that identifies the unmanned aerial vehicle (UAV) from a storage medium of the drone;
generating the color pattern signal from the identification code; and
causing the LED to transmit the color pattern signal corresponding to the identification code of the unmanned aerial vehicle (UAV).

4. The system of claim 3, wherein the identification code is an alphanumeric value derived from a serial number of the drone.

5. The system of claim 3, wherein the color pattern signal includes multiple color pattern phases, including:
a standby phase that alerts a target identification device to prepare to identify the drone;
a start phase that alerts the target identification device that a next color pattern is an identifier for the drone;
an identification phase that presents a multiple color patterns representative of an identifier of the drone; and
an end phase that alerts the target identification device that the color pattern signal has ended.

6. A method of identifying a drone, the method comprising:
capturing images of a color pattern emitted from a light emitting diode (LED) of the drone;
transcoding the captured images to extract the color pattern from the captured images;
comparing the color pattern to a registry of information that relates color patterns to drone identifiers; and
identifying the drone based on the comparison performed via the registry.

7. The method of claim 6, wherein the emitted color pattern includes a standby phase and an identification phase, and wherein transcoding the captured images to extract the color pattern from the captured images includes transcoding the identification phase of the emitted color pattern for comparison with the registry.
